(19) United States
(12) Patent Application Publication
(10) Pub. No.: US 2005/0137860 A1
(43) Pub. Date: Jun. 23, 2005

(54) Apparatus and method for controlling frequency band considering individual auditory characteristic in a mobile communication system

(75) Inventor: Hye-Won Nam, Dalseo-gu (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/017,740

(22) Filed: Dec. 22, 2004

(30) Foreign Application Priority Data
Dec. 22, 2003 (KR) 2003-94747

(51) Int. Cl. G10L 19/14

(52) U.S. Cl. 704/205

(57) ABSTRACT

Disclosed is a method for compensating for a specific frequency band taking an individual auditory characteristic into consideration. The method comprises receiving a signal for selecting a mode for shifting a frequency of a received voice signal to an audible frequency; and applying a control signal to a compensation filter according to the selected mode to cause the compensation filter to shift an inaudible frequency of the received voice signal to an audible frequency. The apparatus for controlling a frequency band comprises a controller and a compensation filter.

### PRIORITY

This application claims the benefit under 35 U.S.C. §119(a) of an application entitled “Apparatus and Method for Controlling Frequency Band Considering Individual Auditory Characteristic in a Mobile Communication System” filed in the Korean Intellectual Property Office on Dec. 22, 2003 and assigned Serial No. 2003-94747, the entire contents of which are incorporated herein by reference.

### BACKGROUND OF THE INVENTION

1. Field of the Invention

The present invention relates generally to an apparatus and method for compensating for a frequency band in a mobile communication system. In particular, the present invention relates to an apparatus and method for compensating for a specific frequency band taking an individual auditory characteristic of a mobile terminal's user into consideration.

2. Description of the Related Art

All of the sounds in the world can be roughly classified into speech sounds and natural sounds. The speech sound refers to a human voice, while the natural sound refers to all sounds except the speech sound, such as environmental sounds, machinery sounds, animal sounds, bird sounds, and the like. All of the sounds have their own unique frequency bands.

The audible frequency range of human hearing ranges between 20 Hz and 20 KHz, and it is generally known that most people can hear a sound of a maximum of 10 KHz. Although each person has their own unique audible-frequency bands to which they are particularly sensitive, a frequency band of about 500 Hz to 4 KHz, common to almost all people, is important in determining the clarity of their speech sounds, and occupies 83% of the total speech clarity as illustrated in Table 1.

TABLE 1

| | Voice | Speech | |
|---|---|---|---|
| Frequency (Hz) | Energy (%) | Clarity (%) | Remarks |
| 100˜500 | 60 | 5 | Frequency band |
| 500˜1000 | 35 | 35 | of 500 Hz to 4 KHz |
| 1000˜2000 | 3 | 35 | occupies |
| 2000˜4000 | 1 | 13 | 83% of the total |
| 4000˜8000 | 1 | 12 | speech clarity |

As illustrated in Table 1, the hearing of most people is most sensitive to sounds in a frequency band of 500 Hz to 4 KHz. A high-frequency signal in the frequency band of 2 to 4 KHz, although it has a low voice energy is one of the primary frequency bands for accurately hearing a conversation sound during voice communication over a mobile terminal. If a person has an auditory handicap at the high-frequency band, he/she will have difficulty in discriminating speech sounds at that frequency band although the speech sounds are substantially audible. In other words, although the person with an auditory handicap can perceive the presence of certain speech sounds, he/she has difficulty in correctly discriminating the speech sounds.

In this regard, presbycusis means a progressive reduction in hearing ability, caused by an increase in age, and refers to an aging symptom of a hearing organ. In this case, the auditory handicap chiefly occurs at a high frequency of 2 KHz or higher.

FIG. 1 is a diagram illustrating characteristics of hearing abilities versus ages, based on United States (US) statistics on bradyecoia. According to the US statistics in which 28 million people, or 10% of the US total population, were surveyed, 30% of the population in the age group of 65 years old or older, and 14% of the population between the ages of 45 and 64, suffer from some degree of hearing loss. FIG. 1 shows that hearing abilities linearly decrease at a frequency of 2 KHz or higher as the person ages. In this regard, Table 2 illustrates a relation between hearing loss and hearing ability. If a person cannot hear a voice sound in the decibel range shown in the left hand column then the persons hearing loss is progressively shown as to range from normal to profound.

TABLE 2

| Average Hearing | | |
|---|---|---|
| Ability (dB) | Hearing loss | Remarks |
| 0˜20 | Normal | Normal |
| 21˜40 | Mild | Part of speech sound is |
| | | inaudible. |
| 41˜55 | Moderate | Normal speech sound is partially |
| | | inaudible |
| 56˜70 | Moderately-severe | Loud speech sound is partially |
| | | inaudible. |
| 71˜90 | Severe | Only loud speech sound at ear |
| | | rims is audible. |
| 91 and over | Profound | No speech sound is audible. |

FIG. 2 is a block diagram schematically illustrating a structure of a voice processor according to the prior art. Referring to FIG. 2, a voice signal received over a radio channel, which is coded voice data, is provided to a voice compression/expansion unit 110. The voice compression/expansion unit 110 expands the received voice signal over the entire frequency band according to key manipulation of a user, and outputs resultant coded digital voice data to a codec 120. The codec 120 converts the coded digital voice data into an analog voice signal, and outputs the analog voice signal to a speaker 130 after being amplified according to a gain previously set for the speaker 130. For example, when a user having difficulty in hearing a speech sound at a high-frequency band receives a voice signal “hello,” the user cannot hear the speech sound due to his/her auditory handicap. In this case, the conventional mobile terminal allows the user to increase the level of the all reception signals through a volume control switch mounted thereon so that he/she can discriminate the speech sound. In this case, the mobile terminal increases the level of the voice signals over the entire frequency band. However, when the level of voice signals transmitted through a specific frequency band is very low, the increase in level of the voice signals over the entire frequency band does not greatly contribute to improvement in the speech clarity. Instead, the increase in level of the voice signals over the entire frequency band causes an unnecessary increase in level of the voice signals at a specific frequency band, thereby giving the user unexpected loud sounds, wherein user experiences an overall unpleasant conversation.

As described above, in the conventional method of volume-controlling received signals over the entire frequency band without taking an individual auditory characteristic into consideration, the user may have a difficulty in clearly discriminating speech sounds at a specific frequency band.

### SUMMARY OF THE INVENTION

It is, therefore, an object of the present invention to provide an apparatus and method for variably controlling a specific frequency band of a received voice signal in a mobile communication system.

It is another object of the present invention to provide an apparatus and method for compensating for a specific frequency band by implementing a compensation filter taking an individual auditory characteristic into consideration in a mobile communication system.

To achieve the above and other objects, there is provided a method for controlling a frequency band in a mobile communication system. The method comprises the steps of receiving a signal for selecting a mode for shifting a frequency of a received voice signal to an audible frequency; and applying a control signal to a compensation filter according to the selected mode to cause the compensation filter to shift an inaudible frequency of the received voice signal to an audible frequency.

To achieve the above and other objects, there is provided an apparatus for controlling a frequency band in a mobile communication system. The apparatus comprises a controller for analyzing a frequency band of a voice signal received over a radio channel, and applying a control signal to a compensation filter to shift the frequency band to an audible frequency band; and the compensation filter for compensating for a frequency band in a mode set according to the control signal from the controller.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating characteristics of hearing abilities versus ages;

FIG. 2 is a block diagram schematically illustrating a structure of a voice processor according to the prior art;

FIG. 3 is a diagram schematically illustrating a concept of a compensation filter according to an embodiment of the present invention;

FIG. 4 is a flowchart illustrating a method for compensating for a specific frequency band using a compensation filter in a mobile terminal according to several embodiments of the present invention; and

FIGS. 5A to 5C are block diagrams illustrating a structure of a voice processor including a compensation filter according to embodiments of the resent invention.

### DETAILED DESCRIPTION OF THE PREFERRED EMBODIMENTS

Several preferred embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for conciseness.

Embodiments of the present invention aim at providing a voice service in which clarity of speech sounds is remarkably improved by compensating for a reduction in discrimination in speech sounds, caused by presbycusis, inherent hearing loss, and acquired hearing loss. That is, embodiments of the present invention provide a high-quality voice service in which clarity of speech sounds is considerably improved by compensating for a signal loss at a specific frequency band caused by an individual auditory characteristic using a compensation filter.

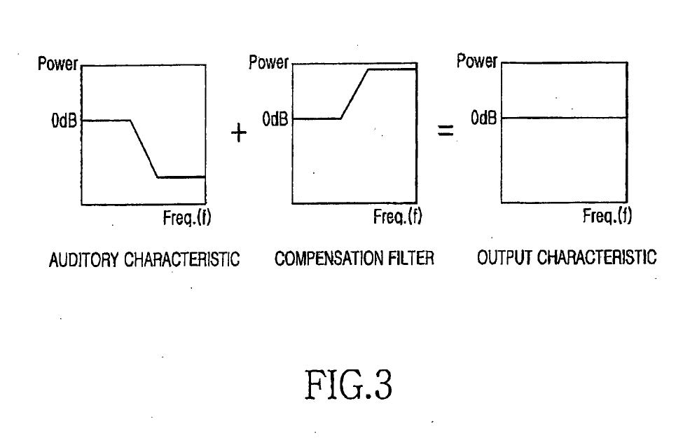

FIG. 3 is a diagram schematically illustrating an conceptual compensation filter according to an embodiment of the present invention. With reference to FIG. 3, a description will be made of a principle of compensating for a linear reduction in level of signals at a specific high-frequency band using a compensation filter designed such that it linearly increases the level of signals at the specific high-frequency band, thereby maintaining a constant signal level over the entire frequency band.

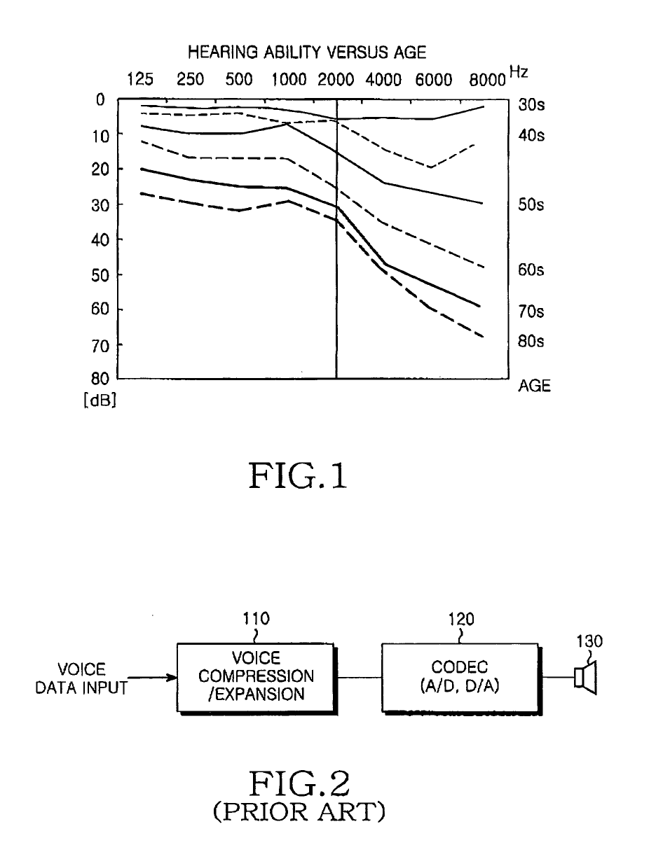

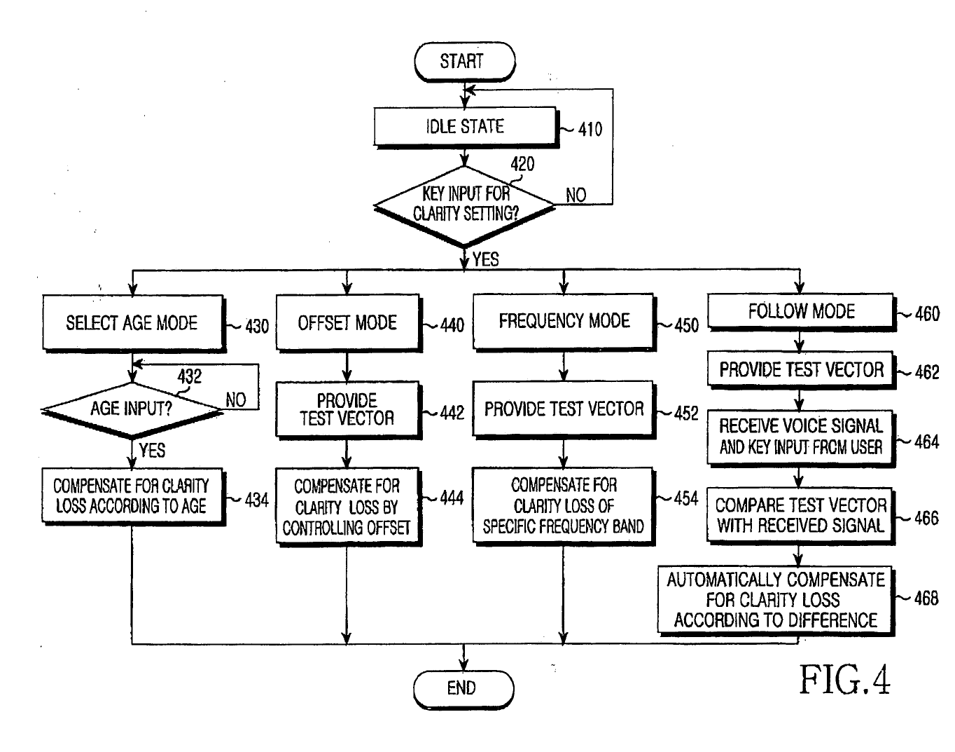

FIG. 4 is a flowchart illustrating a method for compensating for a specific frequency band using a compensation filter in a mobile terminal according to an embodiment of the present invention. Referring to FIG. 4, in step 410, the mobile terminal waits for a key input in an idle state. The mobile terminal determines in step 420 whether a key input for setting clarity of speech sounds is received through its key input unit. If a key input for clarity setting is received, the mobile terminal enters a clarity setting mode and displays a clarity setting menu on its display. The clarity setting menu includes an Age mode, an Offset mode, a Frequency mode, and a Follow mode. In this state, if a user selects one of the displayed modes using the key input unit, the mobile terminal enters the selected mode. According to an embodiment of the present invention, in the Age mode, the mobile terminal compensates for a specific frequency band using the characteristics of hearing ability versus age illustrated in FIG. 1, and in the Offset mode, the mobile terminal compensates for a specific frequency band on an offset basis. In the Frequency mode, the mobile terminal controls a specific frequency band of a received voice signal in detail, and in the Follow mode, the mobile terminal automatically controls a frequency band by determining the individual frequency band at which the user has a difficulty in discriminating speech sounds.

### First Embodiment

### Age Mode

In the first embodiment of the present invention, the mobile terminal compensates for a specific frequency band using the characteristics of hearing ability versus age illustrated in FIG. 1.

In step 430, if the user selects the Age mode for the clarity setting using the key input unit, a controller of the mobile terminal enters the Age mode and displays an Age mode menu on the display. The controller determines in step 432 whether an age of the user is input using the key input unit having a plurality of alphanumeric keys. If an age of the user is input, the controller access, in step 434, frequency characteristic data for the input age stored in a database or a memory included in the mobile terminal. Upon accessing the frequency characteristic data for the input age, the controller applies a control signal to a compensation filter included in the mobile terminal, and the compensation filter compensates for a loss of the frequency band according to the control signal.

For example, assuming that the user of the mobile terminal is 60 years old, if the controller receives a key input signal corresponding to the age of 60 through the key input unit, the controller applies a control signal to the compensation filter so as to design a compensation filter corresponding to frequency characteristic data for the age of 60. In this case, the mobile terminal previously stores filter coefficients for setting compensation filters for respective ages in its memory, and sets a compensation filter using the filter coefficients according to the control signal so that the compensation filter compensates for attenuation of voice signals according to the input age.

### Second Embodiment

### Offset Mode

In the second embodiment of the present invention, the mobile terminal compensates for a specific frequency band on an offset basis.

In step 440, if the user selects the Offset mode for the clarity setting using the key input unit, the controller enters the Offset mode and displays an Offset mode menu on the display. In step 442, the controller applies a control signal to a modem to provide the user with a predetermined sample voice source through a speaker. The sample voice source will be referred to as a “test vector.” For example, it will be assumed herein that a voice source “hello” is provided as a test vector. In this case, if the user has perceived the presence of a sound corresponding to the voice source “hello” provided through the speaker, but has difficulty in correctly discriminating the voice source, the controller proceeds to step 444. In step 444, the controller applies a control signal to a compensation filter included in the modem based on a key input signal input through alphanumeric keys and a direction key, which are mounted on the key input unit. By applying a control signal to the compensation filter, the controller increases the frequency at which the user cannot discriminate the voice source, by a frequency offset, thereby determining the frequency band at which the user can discriminate the voice source. That is, the controller provides an offset to a compensation filter in the modem that provides the voice source based on a key input signal input by the user, thereby determining the frequency band at which the user can discriminate voice source.

For example, if the user can discriminate a leading-part voice source “he . . . ” having a frequency band of 800 to 1000 Hz and has perceived the presence of a following-part voice source “ . . . llo” having a frequency band of 500 to 700 Hz but cannot discriminate the following-part voice source, the user increases the frequency band of 500 to 700 Hz of the following-part voice source “ . . . llo” to a frequency band of 800 to 1000 Hz, using the alphanumeric keys and the direction key, mounted on the key input unit. That is, the controller shifts the frequency band of the following-part voice source “ . . . llo” to the frequency band where it is audible so that the full voice source “hello” is audible over the same frequency band of 800 to 1000 Hz.

In this case, the controller can shift a frequency band at which the user has a difficulty in discriminating the voice source, based on a key input signal input through an Up/Down-direction key mounted on a side of the mobile terminal. After compensating for a reduction in clarity by shifting the frequency band by the offset, the controller can provide the compensated voice source through the test vector. The key input signal for the offset control can be displayed on the display using a graph icon and/or a volume-bar icon.

### Third Embodiment

### Frequency Mode

In the third embodiment of the present invention, the mobile terminal controls a specific frequency band of a received voice signal in detail thereby to provide a more perfect voice source.

In step 450, if the user selects the Frequency mode for the clarity setting-using the key input unit, the controller enters the Frequency mode and displays a Frequency mode menu on the display. In step 452, the controller applies a control signal to the modem to provide the user with a predetermined sample voice source through the speaker. The sample voice source will be referred to as a “test vector.” For example, it will be assumed herein that a voice source “hello” is provided as a test vector. In this case, if the user has perceived the presence of a sound corresponding to the voice source “hello” provided through the speaker, but has a difficulty in correctly discriminating the voice source, the controller proceeds to step 454. In step 454, the controller applies a control signal to a compensation filter included in the modem based on a key input signal input through alphanumeric keys and a direction key, which are mounted on the key input unit. By applying a control signal to the compensation filter, the controller increases the energy level of each frequency at which the user cannot discriminate the voice source, thereby determining the frequency band at which the user can discriminate the voice source. That is, the controller provides energy level information to a compensation filter in the modem that provides the voice source based on a key input signal input by the user, thereby determining the frequency band at which the user can discriminate voice source.

For example, if the user cannot perceive the presence of the voice source “hello” having a frequency band of 800 to 1000 Hz and thus cannot discriminate the voice source, the user increases the energy level of each frequency by 4 to 8 dB with the alphanumeric keys and the direction key mounted on the key input unit using an equalizer screen displayed on the display, thereby providing an audible voice source having the frequency band of 800 to 1000 Hz. In this manner, it is possible to compensate for the frequency band in detail. That is, when the quality of a reproduced voice is poor or a specific voice band is vague, the user can control the energy level of each frequency in detail.

In this case, the controller can control an energy level of each frequency at which the user has a difficulty in discriminating the voice source, based on a key input signal input through an Up/Down-direction key mounted on a side of the mobile terminal. After compensating for a reduction in clarity by controlling the energy level of each the frequency, the controller can provide the compensated voice source through the test vector. The key input signal for the energy level control can be displayed on the display using a graph icon and/or a volume-bar icon.

### Fourth Embodiment

### Follow Mode

In the fourth embodiment of the present invention, the mobile terminal controls the clarity of speech sounds according to an individual auditory characteristic.

In step 460, if the user selects the Follow mode for the clarity setting using the key input unit, the controller enters the Follow mode and displays a Follow mode menu on the display. In step 462, the controller applies a control signal to the modem to provide the user with a predetermined test vector. For example, it will be assumed herein that a voice source “hello” having a frequency band of 800 to 1000 Hz is provided as a test vector. In step 464, the user repeats the voice source “hello” provided through the speaker, using a microphone mounted on the mobile terminal. In step 466, the controller calculates a frequency band of the speech sound received through the microphone, and compares the frequency band of the received speech sound with the frequency band of the test vector. In step 468, the controller applies a control signal corresponding to a difference between the frequency bands to the compensation filter, thereby compensating for a reduction in clarity.

For example, it will be assumed that after the mobile terminal provides a voice source “hello” having a frequency band of 800 to 1000 Hz as a test vector, the user repeats the voice source by providing a leading-part voice source “he . . .” having a frequency band of 600 to 800 Hz and a following-part voice source “ . . . llo” having a frequency band of 400 to 500 Hz using the microphone. In this case, in step 466, the controller calculates a frequency band of the speech sound received through the microphone, and compares the frequency band (800 to 1000 Hz) of the test vector with the frequency band (600 to 800 Hz) of the leading-part voice source of the received speech sound and the frequency band (400 to 500 Hz) of the following-part voice source of the received speech sound, respectively. In step 468, the controller applies control signals corresponding to respective differences between the frequency bands to the compensation filter, thereby automatically compensating for a reduction in clarity.

Although, the embodiments were described individually, this was not intended to be limiting. Of course, one of ordinary skill in the art would understand that the above four embodiments may be combined into a single embodiment or any number of combinations thereof.

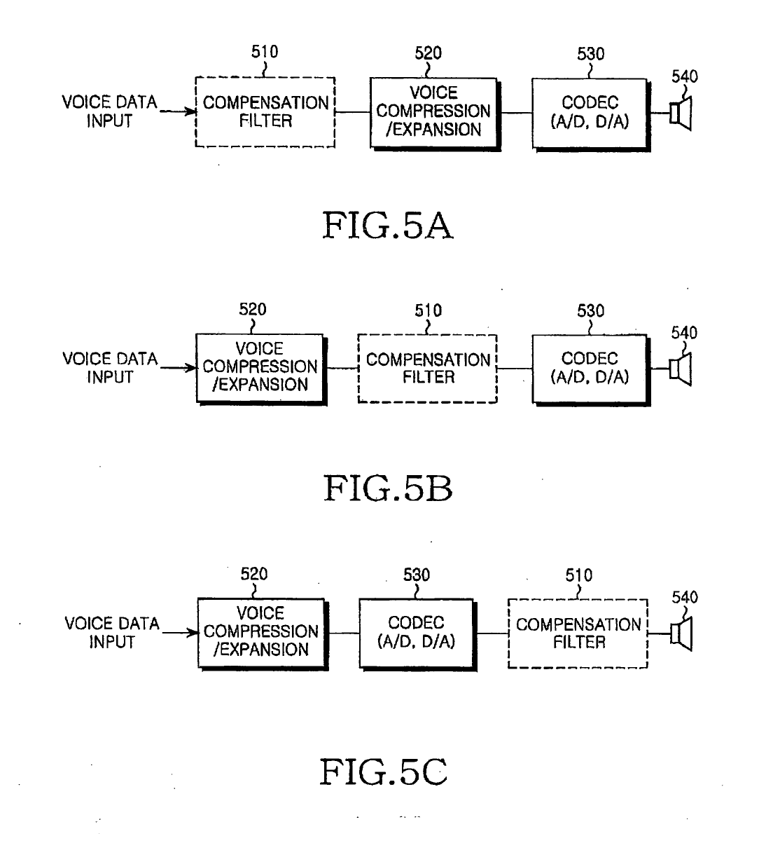

FIG. 5A is a block diagram schematically illustrating a structure of a modem including a compensation filter according to an embodiment of the present invention. Referring to FIG. 5A, a coded radio frequency (RF) signal received over a radio channel is converted into a digital signal by an RF processor (not shown). The digital signal is applied to a compensation filter 510. At this point, a controller (not shown) of the mobile terminal analyzes a frequency band of the voice signal and applies a control signal corresponding to a key input signal from the user to the compensation filter 510. The compensation filter 510 compensates for the frequency band of the voice signal according to the control signal provided from the controller and outputs the frequency-compensated voice signal to a voice compression/expansion unit 520. The voice compression/expansion unit 520 decodes the frequency-compensated voice signal and outputs the decoded voice signal to a codec 530. The codec 530 converts the decoded voice data into a digital bitstream using pulse code modulation (PCM), and outputs the converted voice data through a speaker 540 as an analog voice signal. In FIG. 5A, the compensation filter 510 is arranged in front of the voice compression/expansion unit 520 to compensate for a frequency band before decoding the received voice signal.

FIG. 5B is a block diagram schematically illustrating a structure of a modem including a compensation filter according to another embodiment of the present invention. Referring to FIG. 5B, a coded voice signal received over a radio channel is input to a voice compression/expansion unit 520. The voice compression/expansion unit 520 decodes the analog voice signal into its original voice signal and outputs the decoded voice signal to a compensation filter 510. At this point, a controller of the mobile terminal analyzes a frequency band of the received voice signal and applies a control signal to the compensation filter 510 so that the compensation filter 510 can compensate for the frequency band according to the user's request. Then the compensation filter 510 compensates for the frequency band of the received voice signal, at which the user has a difficulty in discriminating the voice signal, according to the control signal provided from the controller. The digital voice data having the compensated frequency band is applied to a codec 530. The codec 530 converts the frequency-compensated voice data into a digital bitstream using pulse code modulation (PCM), and outputs the converted voice data through a speaker 540 as an analog voice signal having an audible frequency band. In FIG. 5B, the compensation filter 510 is arranged at the end of the voice compression/expansion unit 520 to compensate for a frequency band after decoding the received voice signal. Here, the compensation filter 510 is realized with a digital filter using digital signal processing.

FIG. 5C is a block diagram schematically illustrating a structure of a modem including a compensation filter according to another further embodiment of the present invention. Referring to FIG. 5C, a coded voice signal received over a radio channel is input to a voice compression/expansion unit 520. The voice compression/expansion unit 520 decodes the analog voice signal into its original voice signal and outputs the decoded voice signal to codec 530. The codec 530 converts the decoded voice data into a digital bitstream using pulse code modulation (PCM), and outputs the converted analog voice signal to a compensation filter 510. At this point, a controller of the mobile terminal analyzes a frequency band of the received voice signal and applies a control signal to the compensation filter 510 so that the compensation filter 510 can compensate for the frequency band according to the user's request. Then the compensation filter 510 compensates for the frequency band of the received voice signal, at which the user has difficulty in discriminating the voice signal, according to the control signal provided from the controller. Here, the compensation filter 510 can be implemented with an analog filter made up of resistors and capacitors.

In sum, the controller provides the user with a test vector (or test sound) according to a specific mode selected for clarity setting, and controls the compensation filter of FIGS. 5A to 5C according to a key input from the user in such a manner that the compensation filter compensates for a frequency band according to an individual auditory characteristic.

As can be understood from the foregoing description, embodiments of the present invention provide a high-quality voice service in which clarity of speech sounds is considerably improved by compensating for a signal loss at a specific frequency band caused by an individual auditory characteristic using a compensation filter. That is, embodiments of the present invention provide a voice service in which clarity of speech sounds is remarkably improved by compensating for a reduction in discrimination in speech sounds, caused by presbycusis, inherent hearing loss, acquired hearing loss, and other reasons.

While the invention has been shown and described with reference to a certain preferred embodiment thereof, it will be understood by those skilled in the art that various changes in form and details may be made therein without departing from the spirit and scope of the invention as defined by the appended claims.

1. A method for controlling a frequency band in a mobile communication system, the method comprising the steps of:
receiving a signal for selecting a mode for shifting a frequency of a received voice signal to an audible frequency; and
applying a control signal to a compensation filter according to the selected mode to cause the compensation filter to shift an inaudible frequency of the received voice signal to an audible frequency.

2. A method for shifting an inaudible frequency band to an audible frequency band in a mobile communication system, the method comprising the steps of:
receiving a signal for selecting an age mode to shift a frequency of a received voice signal to an audible frequency;
receiving data corresponding to an age input from a key input unit according to the age mode; and
applying a control signal to a compensation filter considering the data, to cause the compensation filter to shift an inaudible frequency band of the received voice signal to an audible frequency band.

3. A method for shifting an inaudible frequency band to an audible frequency band in a mobile communication system, the method comprising the steps of:
receiving a signal for selecting an offset mode to shift a frequency of a received voice signal to an audible frequency;
receiving a predetermined offset from a key input unit according to the offset mode; and
applying a control signal to a compensation filter considering the offset, to cause the compensation filter to shift an inaudible frequency of the received voice signal to an audible frequency.

4. A method for shifting an inaudible frequency band to an audible frequency band in a mobile communication system, the method comprising the steps of:
receiving a signal for selecting a frequency mode to shift a frequency of a received voice signal to an audible frequency;
receiving a signal for controlling an energy level of each frequency from a key input unit according to the frequency mode; and
applying a control signal to a compensation filter according to the signal for controlling an energy level of each frequency, to cause the compensation filter to control an energy level of each frequency to increase clarity.

5. A method for shifting an inaudible frequency band to an audible frequency band in a mobile communication system, the method comprising the steps of:
receiving a signal for selecting a follow mode to shift a frequency of a received voice signal to an audible frequency;
providing a sample voice signal having a predetermined frequency band according to the follow mode;
receiving a voice signal from a microphone in response to the sample voice signal, and calculating a frequency difference between the sample voice signal and the received voice signal; and
applying a control signal corresponding to the frequency difference to a compensation filter to cause the compensation filter to compensate for an inaudible frequency band.

6. An apparatus for controlling a frequency band in a mobile communication system, the apparatus comprising:
a controller for analyzing a frequency band of a voice signal received over a radio channel, and applying a control signal to a compensation filter to shift the frequency band to an audible frequency band; and
the compensation filter for compensating for a frequency band in a mode set according to the control signal from the controller.

7. The apparatus of claim 6, further comprising:
a voice compression/expansion unit for decoding the radio voice signal received over the radio channel into its original voice signal; and
a codec for converting the frequency-compensated voice signal into an analog voice signal and outputting the analog voice signal through a speaker.

8. The apparatus of claim 6, wherein the compensation filter is a digital filter, arranged in front of the voice compression/expansion unit, for shifting a frequency band of the received voice signal to an audible frequency band according to the control signal from the controller.

9. The apparatus of claim 6, wherein the compensation filter is a digital filter, arranged at the end of the voice compression/expansion unit, for shifting a frequency band of the decoded voice signal to an audible frequency band according to the control signal from the controller.

10. The apparatus of claim 7, wherein the compensation filter is an analog filter, arranged at the end of the codec, for shifting a frequency band of the decoded analog signal to an audible frequency band according to the control signal from the controller.
